(19) United States
(12) Patent Application Publication
(10) Pub. No.: US 2006/0054369 A1
(43) Pub. Date: Mar. 16, 2006

(54) Support frame device with locating function

(76) Inventor: Ming-Hui Pan, Taipei (TW)

Correspondence Address: G. LINK CO,. LTD, 3550 BELL ROAD, MINOOKA, IL, 60447, US

(21) Appl. No.: 10/938,611

(22) Filed: Sep. 13, 2004

(51) Int. Cl. B60K 11/04

(52) U.S. Cl. 180/68.4

(57) ABSTRACT

A support frame device with locating function, which is for joining a fan and a radiator, includes a support part and a plurality of joining parts. The support part has a hollow space with a plurality of engaging holes for being joined to the radiator by way of fastening elements with the engaging holes at one lateral side thereof and being joined to the fan at another lateral side thereof with catch parts and locating plates holding the fan. Each of the joining parts has a receiving through hole for fitting with a fixing part and an end of each joint part is joined to the support part and another end thereof is attached to the a main board by way of the fixing part, which is composed of a fastener and an elastic member. Therefore, the support frame device can provide effects of quick locating and convenient assembling.

### BACKGROUND OF THE INVENTION

1. Field of the Invention

The present invention is related to a support frame device with locating function for a CPU and particularly to a support frame device capable of assembling with a fan and having locating function.

2. Brief Description of Related Art

Referring to FIG. 1, the conventional support frame device 13 comprises a frame member 131 and a plurality of locating parts 132. The frame member 131 at the central position thereof can be attached to a CPU 14 for conducting heat generating from the CPU 14 to a radiator 12 joined to the frame member 131 during the CPU 14 in a state of running. The radiator 12 is joined to the frame member by way of welding, gluing or engaging. Each of the locating parts includes an actuation member 132a and a follower member 132b and the actuation member 132a is inserted into the follower member 132b. When the actuation member 132a is pressed downward, a hook part 132c provided at the lower lateral side of the follower member 132b stretching outward to hold the main board. When the actuation part 132a moves upward to be back to the original position thereof, the hook part 132c then moves back to the original state. That is, the concept of entering a hole and expanding the hook part 132c is applied to each of the locating parts 132 so as to obtain the effect of holding by way of hook part so that the preceding concept is utilized to allow the frame member 131 is fixed to the main board 15 in case of the respective locating part 132 passing through a corresponding joining hole 151 of the main board 15 near a CPU fixing base 142 and the central part of the frame member 131 at the same time can contact with the CPU 14 on the operating chip 141.

Referring to FIG. 2 in company with FIG. 1 again, the radiator 12 is attached with a fan 11 at the top thereof and when the fan 11 is in a state of running, the air current generated by the fan 11 can reach a support device 13 via the radiator 12. for performing heat dissipation.

However, the conventional support frame device 13 has disadvantages listing underneath:

1. It is required expensive die fabricating cost in order to make the conventional support frame device 13.

2. It is required much more work to make the fan 11 and the radiator 12 being assembled to the conventional support frame device 13 so that it is very inconvenient to complete the assembling job.

3. The fan 11 and the radiator 12 are not detachably assembled to the conventional support frame 13 so that it is impossible to achieve convenience of part replacement.

4. The radiator has to be provided with a recess part 121 for the lead wire 111 of the fan 11 being able to extend outward easily.

5. The frame member 131 of the support frame device 13 is dispose under the radiator 12 as shown in FIG. 3 and it is easy for the blowing down air current of the fan 11 to occur a phenomenon of counter flowing on top of the frame member 13 to degrade effect of the heat dissipation largely.

### SUMMARY OF THE INVENTION

A primary object of the present invention is to provide a support frame device, which is capable of being assembled easily and conveniently;

Another object of the present invention is to provide a support frame device, which costs less tremendously;

A further object of the present invention is to provide a support frame device, which can be located quickly; and

A further object of the present invention is to provide a support frame device, which is capable of avoiding counter airflow pressure.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a disassembled perspective view of the conventional support frame device;

FIG. 2 is a perspective view of the conventional support frame device;

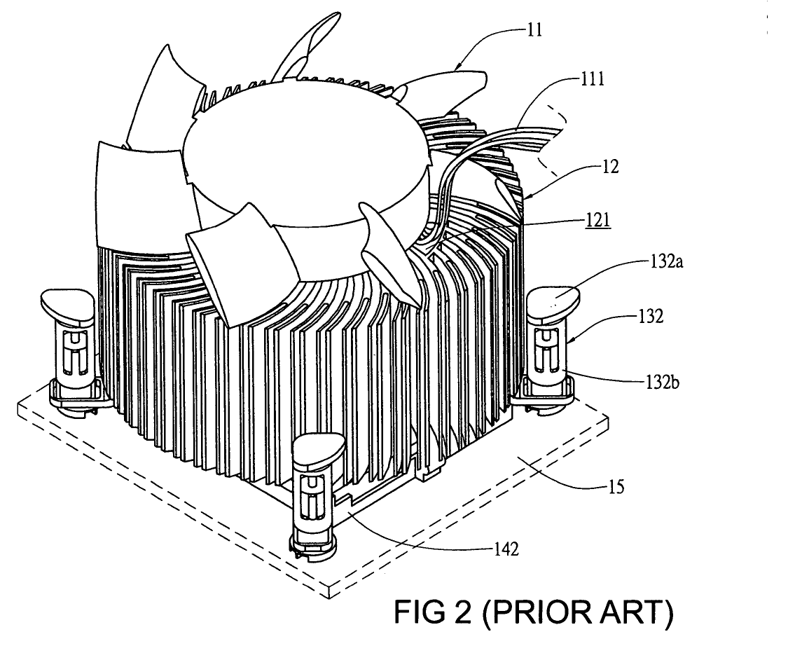

FIG. 3 is a side sectional view of the conventional support frame device shown in FIG. 2;

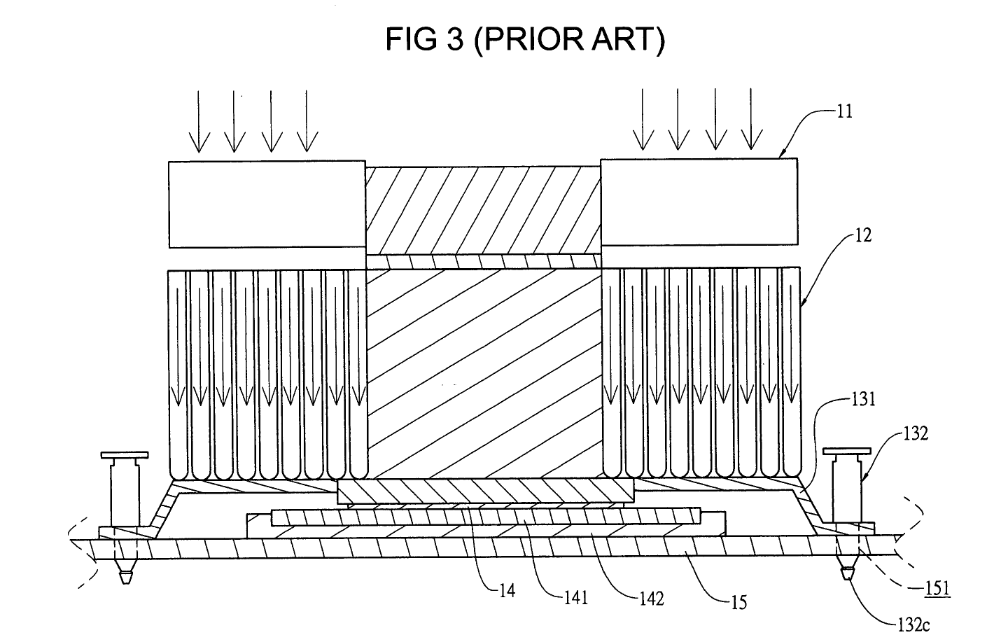

FIG. 4 is a disassembled perspective view of a support frame device according to the present invention in the first embodiment thereof;

FIG. 5 is an assembled perspective view of the support frame device shown in FIG. 4;

FIG. 6 is a disassembled perspective view of another frame device according to the present invention in the second embodiment thereof;

FIG. 7 is an assembled perspective view of another frame device according to the present invention in the second embodiment thereof;

FIG. 8 is a side sectional view of the support frame device shown in FIG. 5; and

FIG. 9 is a side sectional view of the support frame device shown in FIG. 8.

### DETAILED DESCRIPTION OF THE INNVENTION

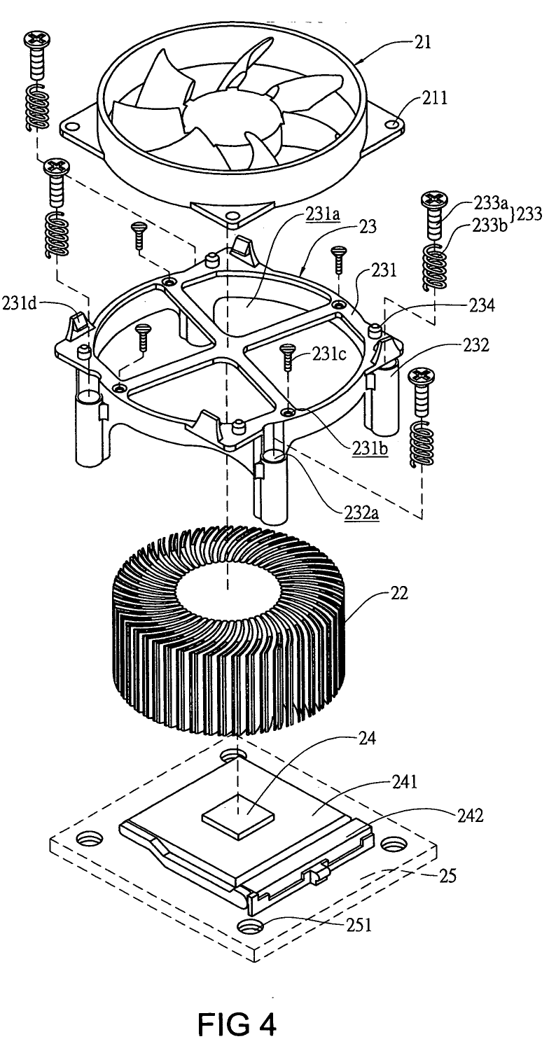

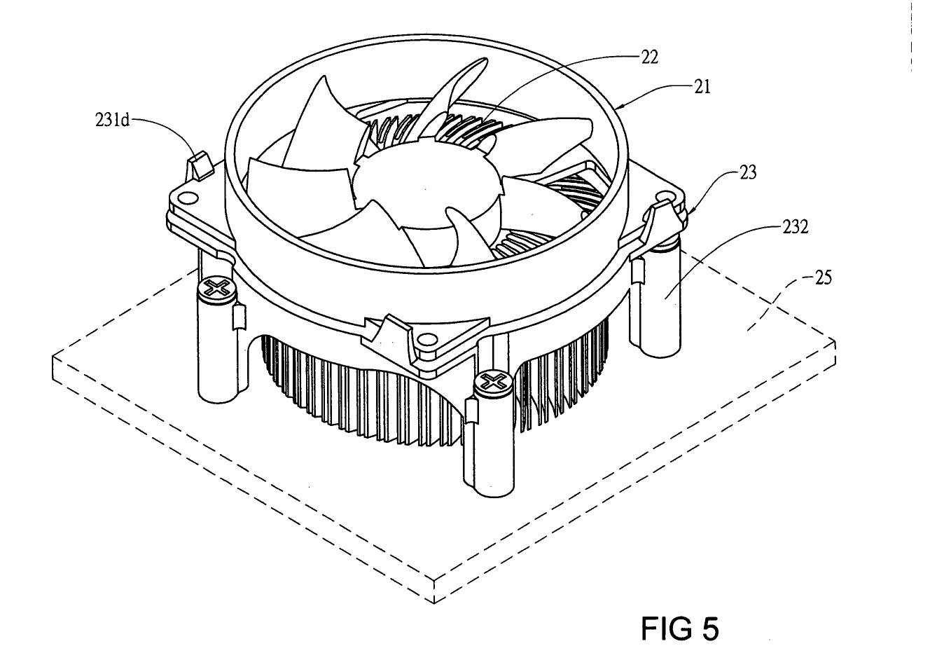

Referring to FIGS. 4 and 5, the first embodiment of the support frame device with locating function according to the present invention is illustrated. The support device 23 is attached o a cylindrical radiator 22 while in use so that the integral appearance thereof provides an annular shape. The support device 23 mainly includes a support part 231 and a plurality of joining parts 232. The support part 231 is provided with a plurality of through openings 231 a therein and a plurality of locators at the upper side thereof for passing through locating holes 211 provided at a fan 21. The support part 231 further has a plurality of engaging holes 231b and a plurality of fasteners 231c can engage the support part 231 to the radiator 22 via passing through the engaging holes 231b such that the bottom of the support part 231 can be joined to the radiator 22 tightly.

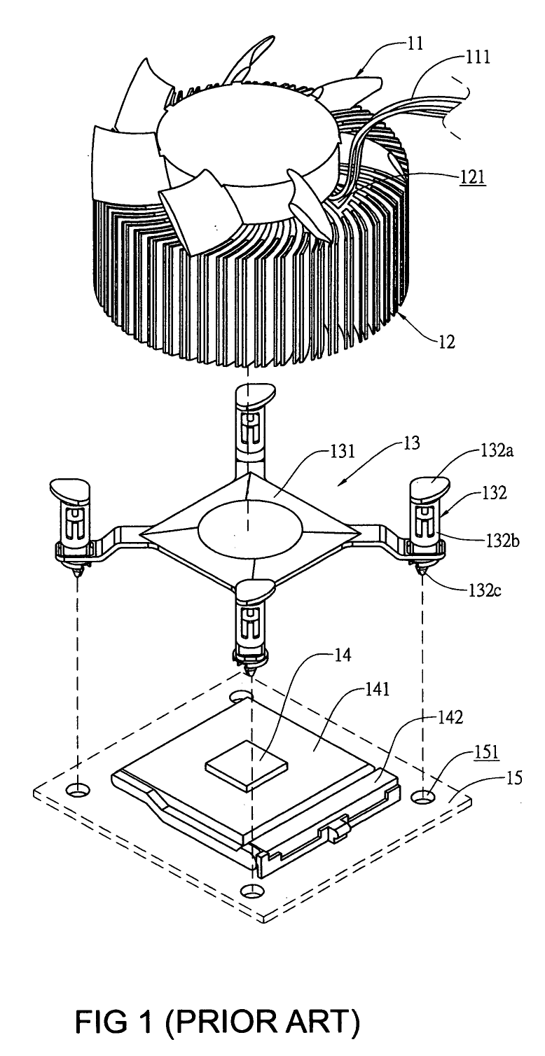

Each of the joining parts 232 has a joining through hole 232a for receiving a fixing part 233. The joining through hole 232a in the present embodiment is only for taking an example and a threaded hole or any other type of hole providing joining function can be used instead for joining the fixing part 233. The fixing part 233 shown includes a fastener 233a and an elastic member 233b but any other type of fixing part 233 can be utilized instead such as the fixing part 132 shown in FIG. 1 of the prior art having an actuation member 132a and a follower member 132b. The joining parts 232 are attached to the support part 231 at upper ends thereof and attached to a main board 25 at lower ends thereof with the fixing part 233 by way of the fastener 233a passing through the elastic member 233b and engaging with engaging holes 251 at the main board 25 next to a CPU fixing base 242. Right at the moment, the radiator 22 can be joined to a CPU 24 on an operating chip 241 and fast locating and convenient assembling can be reached effectively.

Besides, the preceding support part 231 can be provided with at least a catch part 231d to hold the fan 21 while the fan 21 is pressed in place so as to prevent the fan 21 from occurring vibration.

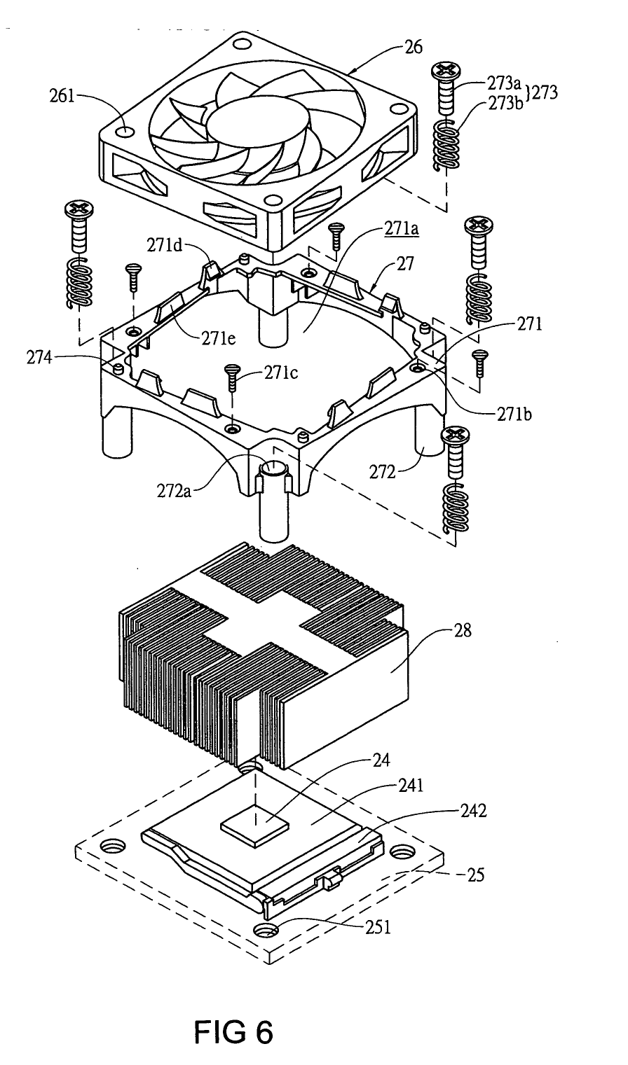

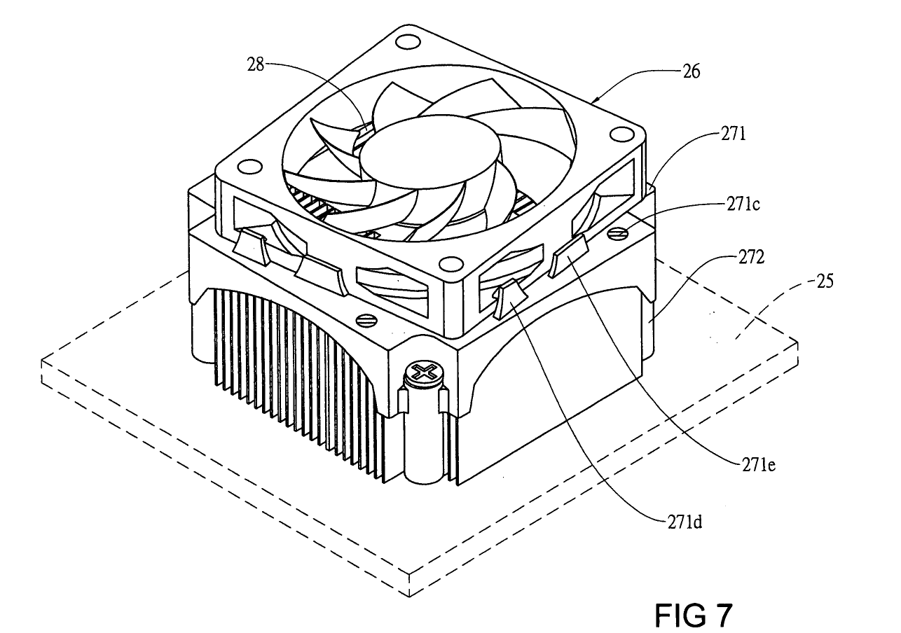

Referring to FIGS. 6 and 7, the second embodiment of the present invention is illustrated. The support frame device 27 is made for accommodating a polygon shaped radiator 28 so that the appearance thereof can be seen having a polygon shaped outer frame. The support device 27 mainly includes a support part 271 and a plurality of joining parts 272. The support part 271 is provided with a hollow part 271a therein and a plurality of locators 274 at the upper side thereof for passing through locating holes 261 provided at a fan 26. The support part 271 further has a plurality of engaging holes 271b and a plurality of fasteners 271c can engage the support part 231 to the radiator 22 via passing through the engaging holes 271b such that the bottom of the support part 271 can be joined to the radiator 28 tightly. Each of the joining parts 272 has a joining through hole 272a for receiving a fixing part 273. The joining through hole 272a in the present embodiment is only for taking an example and a threaded hole or any other type of hole providing joining function can be used instead for joining the fixing part 233. The fixing part 273 includes a fastener 273a and an elastic member 273b but any other type of fixing part can be utilized instead such as the fixing part 132 shown in FIG. 1 of the prior art having an actuation member 132a and a follower member 132b. The joining parts 272 are attached to the support part 271 at upper ends thereof and attached to a main board 25 at lower ends thereof with the fixing part 233 by way of the fastener 233a passing through the elastic member 233b and engaging with engaging holes 251 at the main board 25 next to a CPU fixing base 242. Right at the moment, the radiator 28 can be joined to a CPU 24 on an operating chip 241 and fast locating and convenient assembling can be reached effectively.

Besides, the preceding support part 271 can be provided with at least a catch part 271d to hold the fan 26 while the fan 26 is pressed in place so as to prevent the fan 21 from occurring vibration. Further, the support part 271 can be provided with at least a locating plate 271e for being pressed into the fan 26 to enhance the effect of holding the fan 26 and preventing the fan 26 from occurring vibration.

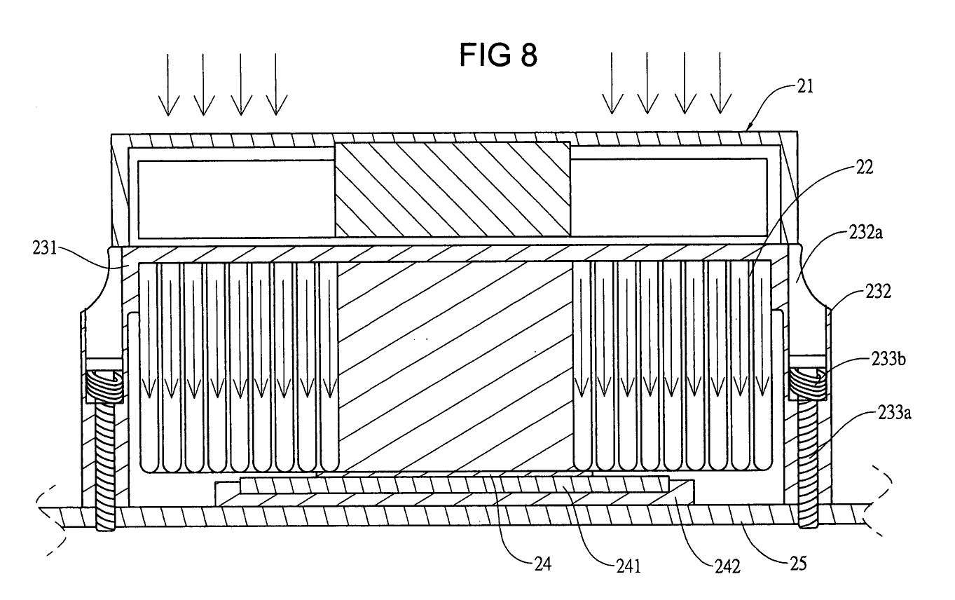

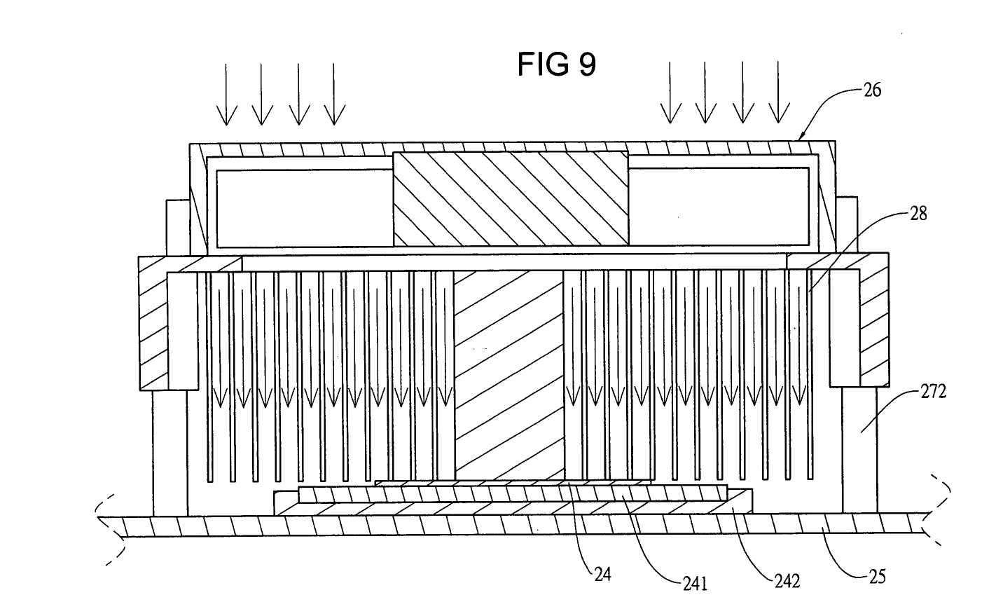

Referring to FIGS. 8 and 9, it can seen from the side sectional views of the first and second embodiments that there is no any obstacles under the radiators (22, 28) and the air current generated by the fans (21, 26) can be blown to the CPU 24, the operating chips 241, the CPU fixing base 242 and the main board 25 directly via the radiators 22, 28 and then discharges outsides. Therefore, comparing to the prior art, the present invention offers much better effectiveness in addition to having easily assembled structure.

While the invention has been described with referencing to preferred embodiments thereof, it is to be understood that modifications or variations may be easily made without departing from the spirit of this invention, which is defined by the appended claims.

What is claimed is:

1. A support frame device with locating function, which is for joining a fan and a radiator, comprising:
a support part with two opposite lateral sides, having a hollow through the lateral sides with a plurality of through engaging holes, being joined to the radiator with a plurality of first fastening element to engage with the engaging holes at one of the lateral sides and being joined to the fan at another one of the lateral sides; and
a plurality of joining parts, each of the joining parts having a receiving through hole to fit with a fixing part, being joined to the support part at an end thereof and being attached to the a main board at another end thereof with the fixing part;
whereby, the support frame device can provide effect of quick locating and convenient assembling.

2. The support frame device with locating function as defined in claim 1, wherein the receiving hole can be a plain through hole.

3. The support frame device with locating function as defined in claim 1, wherein the receiving hole can be threaded hole.

4. The support frame device with locating function as defined in claim 1, wherein the fixing part includes a second fastening element and an elastic member.

5. The support frame device with locating function as defined in claim 1, wherein the fixing part includes an actuation member and a follower member.

6. The support frame device with locating function as defined in claim 1, wherein the support part provides at least a catch part for pressing into and holding the fan in case of the fan being joined to the support part to prevent the fan from occurring vibration.

7. The support frame device with locating function as defined in claim 1, wherein the support part provides at least a locating plate to enhance the effect of locating the fan and preventing the fan from occurring vibration in case of the fan being joined to the support.

8. A support frame device with locating function, which is for joining a fan and a radiator, comprising:
a support part with two opposite lateral sides, having a hollow space through the lateral sides for being joined to the radiator at one of the lateral sides and being joined to the fan at another one of the lateral sides; and
a plurality of joining parts, each of the joining parts having a receiving through hole for fitting with a fixing part, an end thereof being joined to the support part and another end thereof being attached to the a main board by way of the fixing part;
whereby, the support frame device can provide effect of quick locating and convenient assembling.

9. The support frame device with locating function as defined in claim 8, wherein the receiving hole can be a plain through hole.

10. The support frame device with locating function as defined in claim 8, wherein the receiving hole can be threaded hole.

11. The support frame device with locating function as defined in claim 8, wherein the fixing part includes a second fastening element and an elastic member.

12. The support frame device with locating function as defined in claim 8, wherein the fixing part includes an actuation member and a follower member.

13. The support frame device with locating function as defined in claim 8, wherein the support part provides at least a catch part for pressing into and holding the fan in case of the fan being joined to the support part to prevent the fan from occurring vibration.

14. The support frame device with locating function as defined in claim 8, wherein the support part provides at least a locating plate to enhance the effect of locating the fan and preventing the fan from occurring vibration in case of the fan being joined to the support.

15. A support frame device with locating function, which is for joining a fan and a radiator, comprising:
a support part with two opposite lateral sides, having a hollow space through the lateral sides for being joined to the radiator at one of the lateral sides and being joined to the fan at another one of the lateral sides; and
a plurality of joining parts, each of the joining parts having an end thereof being joined to the support part and another end thereof being attached to the a main board;
whereby, the support frame device can provide effect of quick locating and convenient assembling.

16. The support frame device with locating function as defined in claim 15, wherein the support part provides at least a catch part for pressing into and holding the fan in case of the fan being joined to the support part to prevent the fan from occurring vibration.

17. The support frame device with locating function as defined in claim 15, wherein the support part provides at least a locating plate to enhance the effect of locating the fan and preventing the fan from occurring vibration in case of the fan being joined to the support.
